(19) United States
(12) Patent Application Publication
(10) Pub. No.: US 2009/0227452 A1
(43) Pub. Date: Sep. 10, 2009

(54) SPENT FERMENTED GRAIN SOIL ADDITIVE

(76) Inventor: Timothy D. Birthisel, Perrysburg, OH (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/407,430

(22) Filed: Mar. 19, 2009

Related U.S. Application Data
(63) Continuation-in-part of application No. 11/301,171, filed on Dec. 12, 2005.
Application No. 11/301,171 is a continuation-in-part of application No. 11/327,099, filed on Jan. 6, 2006.
Application No. 11/327,099 is a continuation-in-part of application No. 11/327,098, filed on Jan. 6, 2006.
Application No. 11/327,098 is a continuation-in-part of application No. 11/556,290, filed on Nov. 3, 2006.
Application No. 11/556,290 is a continuation-in-part of application No. 11/623,993, filed on Jan. 17, 2007.
Application No. 11/623,993 is a continuation-in-part of application No. 11/757,646, filed on Jun. 4, 2007.
Application No. 11/757,646 is a continuation-in-part of application No. 11/843,409, filed on Aug. 22, 2007.
Application No. 11/843,409 is a continuation-in-part of application No. 12/106,600, filed on Apr. 21, 2008.
Application No. 12/106,600 is a continuation-in-part of application No. 11/301,171, filed on Dec. 12, 2005.
Application No. 11/301,171 is a continuation-in-part of application No. 12/108,307, filed on Apr. 23, 2008.
Application No. 12/108,307 is a continuation-in-part of application No. 12/234,898, filed on Sep. 22, 2008.
Application No. 12/234,898 is a continuation of application No. 11/028,879, filed on Jan. 4, 2005.
Application No. 11/028,879 is a division of application No. 10/245,248, filed on Sep. 16, 2002, now Pat. No. 6,884,756.
(60) Provisional application No. 60/635,553, filed on Dec. 13, 2004.
(60) Provisional application No. 60/642,387, filed on Jan. 7, 2005.
(60) Provisional application No. 60/642,318, filed on Jan. 7, 2005.
(60) Provisional application No. 60/733,633, filed on Nov. 4, 2005.
(60) Provisional application No. 60/759,362, filed on Jan. 17, 2006.
(60) Provisional application No. 60/810,763, filed on Jun. 2, 2006.
(60) Provisional application No. 60/823,264, filed on Aug. 23, 2006.
(60) Provisional application No. 61/037,789, filed on Mar. 19, 2008.
(60) Provisional application No. 60/912,722, filed on Apr. 19, 2007.
(60) Provisional application No. 60/635,553, filed on Dec. 13, 2004.
(60) Provisional application No. 60/913,389, filed on Apr. 23, 2007.
(60) Provisional application No. 60/322,084, filed on Sep. 14, 2001.

(51) Int. Cl. A01N 25/26; A01P 3/00; A01P 13/00; A01P 21/00; A01P 7/04; A01P 19/00; A01P 7/00

(52) U.S. Cl. 504/101

(57) ABSTRACT

A process for enhancing a soil is provided that includes applying a quantity of a free flowing spent fermented grain particulate by broadcast spreading to soil. The particulate provides a sustained release of nutrients from the fermented grain to the soil. The free flowing spent fermented grain particulate has a degree of pitting and porosity that makes it amenable to impregnation with an active agent as a liquid, a solution, a colloid, or a melt. The particulate being then impregnated with an active agent is amenable to coating with a coating layer to retain the active agent in contact with the particulate. A composition is so provided to perform the process.

### CROSS-REFERENCE TO RELATED APPLICATIONS

This application is a continuation-in-part of U.S. Utility Application Serial Number 12/234,898 filed on Sep. 22, 2008; which a divisional application of U.S. Utility application Ser. No. 10/245,248 filed Sep. 16, 2002, which in turn claims priority of U.S. Provisional Application 60/322,084 filed Sep. 14, 2001. This application is a continuation-in-part of U.S. Utility application Ser. No. 11/327,098 filed Jan. 6, 2006, which in turn claims priority of U.S. Provisional Patent Application Ser. No. 60/642,318 filed Jan. 7, 2005. This application is a continuation-in-part of U.S. Utility application Ser. No. 11/327,099 filed Jan. 6, 2006, which in turn claims priority of U.S. Provisional Patent Application Ser. No. 60/642,387 filed Jan. 7, 2005. This application is a continuation-in-part of U.S. Utility application Ser. No. 11/623,993 filed Jan. 17, 2007, which in turn claims priority benefit of U.S. provisional application Ser. No. 60/759,362, filed 17 Jan. 2006. This application is a continuation-in-part of U.S. Utility application Ser. No. 11/556,290 filed Nov. 3, 2006, which in turn claims priority benefit of U.S. Provisional application 60/733,633, filed Nov. 4, 2005. This application is a continuation-in-part of U.S. Utility application Ser. No. 11/757,646 filed Jun. 4, 2007, which in turn claims priority benefit of U.S. Provisional application 60/810,763, filed Jun. 2, 2006. This application is a continuation-in-part of U.S. Utility application Ser. No. 11/843,409 filed Aug. 22, 2007 that in turn priority benefit of U.S. Provisional Application Ser. No. 60/823,264 filed Apr. 23, 2006. This application is a continuation-in-part of U.S. Utility application Ser. No. 12/108,307 filed Aug. 23, 2008 that in turn claims priority from U.S. Provisional Patent Application Ser. No. 60/913,389, filed Apr. 23, 2007. This application is a continuation-in-part of U.S. Utility application Ser. No. 12/106,600 filed Apr. 21, 2008 which in turn claims priority benefit of U.S. Provisional Application Ser. No. 60/912,722 filed on 19 Apr. 2007; and application Ser. No. 12/106,600 is itself a continuation-in-part of U.S. patent application Ser. No. 11/301,171 filed 12 Dec. 2005 which in turn claims priority of U.S. Provisional Patent Application Ser. No. 60/635,553 filed Dec. 13, 2004. This application also claims priority of U.S. Provisional Patent Application Ser. No. 61/037,789 filed Mar. 19, 2008. The content of these priority applications are incorporated herein by reference.

### FIELD OF THE INVENTION

The present invention in general relates to a free flowing granular soil additive and in particular to an additive derived from a fermentation byproduct.

### BACKGROUND OF TH INVENTION

The maintenance of soil as a growth medium for vegetation often requires the addition of fertilizers, amendments, pH adjusting materials and organic material such as humus. The long term control of nutrient release from a soil, as well as maintaining aeration and soil water content, represent serious problems in maintaining optimal plant growth conditions.

Spent fermented grain represents a large volume waste stream from fermentation. While yeast extracts some bioavailable materials during fermentation, especially carbohydrates, considerable nutrient value remains. The composition of spent fermented grain includes partially digested proteins, complex carbohydrates, nutrients associated with living and dead fermentation yeast, as well as porous cellulosic material. Spent fermented corn grain has a CRN value of 4.5-5 percent by weight of organic nitrogen, principally in the form of amino acids and proteins that are available to promote plant growth, in addition to roughly 2 percent by weight phosphate and 1.5 percent by weight potash, all in a natural organic, non polluting, plant available form. In contrast to processed sewage, such as MILORGANITE, being used as a soil additive, spent fermented grain is free of heavy metals, excreted pharmaceuticals, and other contaminants associated with a sewage stream.

Thus, there exists a need for a soil additive based on spent fermented grain that efficiently and economically improves soil quality and thereby enhances growth of a plant in such a soil. There further exists a need for a high surface area spent fermented grain carrier for an active agent for application to soil.

### SUMMARY OF THE INVENTION

A process for enhancing a soil is provided that includes applying a quantity of a free flowing spent fermented grain particulate by broadcast spreading to soil. The particulate provides a sustained release of nutrients from the fermented grain to the soil. The free flowing spent fermented grain particulate has a degree of pitting and porosity that makes it amenable to impregnation with an active agent as a liquid, a solution, a colloid, or a melt. The particulate being then impregnated with an active agent is amenable to coating with a coating layer to retain the active agent in contact with the particulate.

A composition is also provided that includes a free flowing spent fermented grain particulate having a mean particle size of between 5 microns and 6 millimeters and a moisture content of less than 12 total weight percent. The composition can be impregnated or agglomerated with an active agent from 0.001 to 99 total weight percent. An active agent loaded particulate is amenable to coating with a coating overlayer to encompass the particulate and the active agent. A solid, second active agent can be adhered to the coating layer or applied as a melt onto active agent loaded particulate that upon cooling forms a crystallized solid layer of second active agent. The ability to provide sustained release of active agent from within the particulate provides for a more efficient use of the active agent. Additionally, a coating layer through control of composition and thickness provides for a delayed release of the active agent within the particulate.

Spent fermented grain is also ground into fine particles that are agglomerated with resort to a binder to form a carrier granule for the delivery of an active agent.

### DETAILED DESCRIPTION OF THE PREFERRED EMBODIMENTS

The present invention has utility as a soil additive to promote improved plant growth. The present invention relies on an enhanced nutrient package provided by spent fermented grain. As a result, the process of adding spent fermented grain to a soil provides nutrition to beneficial soil microbes as well as essential building blocks to plants including large quantities of nitrogenous material and trace elements. As a result, both soil and aquatic systems are conditioned and amended by naturally adjusting pH, providing moisture retention and improved soil tilth, as well as augmenting commensal and symbiotic species which aid the overall medium community. Unlike prior art products which may contain pathogens, trash, chemical contaminants, heavy metal contaminants, malodifers, disease vector attractants and are generally dark in color, spent fermented grain is formed as a flowable powder upon dehydration and generally has a straw-like color, nonexistent or mild pleasant odor, and a chain of custody assuring freedom from the aforementioned concerns associated with prior art products. According to the present invention, spent fermented grain is dried as a free-flowing granular powder. Typically, the powder has a mean particle size of between 0.1 and 6 millimeters. Preferably, mean granular size is between 0.3 and 0.9 millimeters. The inventive powder is amenable to storage without mildewing.

Spent fermented grain particulate has a number of properties rendering it particularly advantageous as a carrier for biological active ingredients (BAIs and synonymously detailed herein as an active agent) such as a fertilizer, insecticide, larvicide, plant growth regulator, fungicide, herbicide, insect growth regulator, bait attractant or a combination thereof. Without intending to be bound by a particular theory, the activity of yeast in the course of enzymatic metabolism of the grain granules creates a pitted and semi-porous structure to the spent fermented grain particulate and is well suited to be impregnated with liquid active agents to provide sustained release thereof within soil. Typically, an active agent is provided at between 0.01 to 95 total weight percent of spent fermented grain particulate. The inventive particulate is utilized with or without a BAI either through soil surface distribution, foliar application, as an additive for sand top-dressing, or tilling therethrough. Broadcast distribution by any of these methods provides a degree of uniformity of application without the problems of applying a liquid spray of an active agent directly to soil or foliage. The broadcast methodologies detailed in PCT/US08/11912 and co-pending U.S. provisional application 61/100,937 filed 29 Sep. 2008 are specifically intended to be encompassed for the broadcast application of inventive particulate. Typically, the free flowing spent fermented grain particulate is applied to the soil in an amount of between 0.01 and 10,000 kilograms per hectare, with the desired concentration of active agent, if present, largely controlling. Otherwise active agent free particulate is spread to provide a sustained release of nutrients to the soil. Additionally, it is appreciated that fermented grain particulate itself affords a sustained nutrient release of bioavailable nutrients, especially nitrogen. As a result, the use of an inventive free flowing spent fermented grain particulate decreases the need for use of separate synthetic fertilizers.

Grains suitable for formation of free flowing spent fermented grain particulate according to the present invention illustratively include wheat, spelt, rye, oats, corn, barley, and sorghum. It is appreciated that the grain is often milled to a reduced particle size prior to initiation of fermentation.

As used herein “impregnated” is used synonymously with “permeated” and defines a liquid penetrating beneath a particle surface. Impregnation can be uniform through a particle volume or have a liquid concentration gradient between the particle surface and core.

A process for enhancing a crop area includes application of a quantity of free flowing spent fermented grain particulate to the soil and/or the foliage and other aerial parts of the crop or noxious weeds. This grain particulate provides a sustained release of nutrients to the crop area, helps to stabilize the formulation in storage, handling, and positionally at the application target, and is well suited as a carrier for a liquid BAI owing to the porosity associated with the particulate. A BAI is readily impregnated into or coated with or onto spent fermented grain particulate by capillary action and/or electrostatic forces that draws a liquid active agent, a solution of active agent, a colloidal suspension of active agent, or a melt of an active agent into the interior and/or onto the surface of a spent fermented grain particle. the resulting formulation may be useful as is, or may be reformed by other formulating processes such as blending, milling, screening, drying, extrusion and agglomeration so as to allow it to fit various specific purposes such as a soil-targetted dispersible granule, a foliar-adhering or effervescent granule, and any combinations of these. As a result, the spent fermented grain particulate is well suited as an internalized carrier for biologically active agents. Owing to the porosity and easy processability of the particulate, release of an active agent therefrom is readily used to provide a targeted, sustained release not only of particulate nutrients to the soil but also the active agent carried therewith.

A process for forming a free flowing spent fermented grain particulate in simplest form is based upon the drying of grain particulate that has been spent through the fermentation process. Optionally, spent fermented grain is milled to a mean particle size of between about 5 microns and 6 millimeters. In instances when the particulate is used as a carrier for an active agent, a sieving and/or agglomeration operation is performed to narrow the size distribution of the particulate. Porous grain particulate for delivery of an active agent is sieved preferably to within ±25% of the mean particle size. Preferably, the spent fermented grain is dried to a moisture content of less than 12 total weight percent. Preferably, the moisture content of free flowing spent fermented grain particulate is between 1 and 10 total percent.

The drying of spent fermented grain particulate is readily performed through spreading onto a drying screen or other similar surface. It is appreciated that the drying process is accelerated by heating the spent fermented grain at a temperature of less than 100° Celsius to form the free flowing spent fermented grain particulate. Optionally, vacuum is applied during the application of heat to further accelerate the loss of moisture content by the spent fermented grain. Optionally, the dried spent fermented grain is deoiled to remove residual hydrophobic constituents from the spent fermented grain. Deoiling is readily performed through exposure to lipophilic organic solvents such as acetone, hexane, petroleum distillates, methyl ethyl ketone, toluene, petroleum distillates, alcohols, steam, carbon dioxide, and combinations thereof, either at ambient pressure or under supercritical pressure conditions. It is appreciated that solvent deoiling is readily performed with solvent distillation to isolate oils from the spent fermented grain and with solvent recycle to form a closed solvent system. The resultant deoiled free flowing spent fermented grain particulate is particularly well suited for coating or impregnation with hydrophilic or lipophilic active agents.

A free flowing spent fermented grain particulate regardless of whether deoiled to render the same hydrophilic or retaining a hydrophobic character from the fermentation process is readily impregnated with an active agent that is: a liquid at 20° Celsius, a solution of an active agent that is solid at 20° Celsius, a melt of an active agent that is solid at 20° Celsius, or a suspension of active agent colloids. A colloidal active agent preferably has an average colloid size smaller than pore dimensions within the grain particulate. It is appreciated that the porosity characteristics of a grain particulate are largely controlled by factors of the type of grain and the conditions under which fermentation occurred.

It is appreciated that free flowing spent fermented grain particulate is readily overlayered with a tackifying agent and a powdered active agent for use as a carrier. However, it is noted that this approach fails to take advantage of a notable attribute of the spent fermented grain as an internalizing carrier and accordingly does not necessarily provide the sustained release associated with an active agent being released from grain particulate pores.

Subsequent to impregnation of free flowing spent fermented grain particulate with an active agent in the form of a liquid, solution, melt, or colloidal suspension, the resultant sustained release active agent loaded grain particulate is readily applied to soil. Optionally, an active agent loaded particulate is farther coated to form a coating layer to retain the active agent in contact with the particulate.

A coating layer is present on an active agent loaded particle in an amount ranging from 0.1% to 75% by weight of the total dry weight of the particle. In a further embodiment, the coating layer is present in an amount ranging from 1% to 25% by weight of the total dry weight of the particle. A coating layer is included overlayered on a particle as necessary to produce a seal over the particle and impregnated active agent or promote cohesion with a second, solid agent mixed with the coating layer or applied thereover. A coating layer may be bentonite clay, carbohydrate, protein, lipid, synthetic polymer, glycolipid, glycoprotein, lipoprotein, lignin, a lignin derivative, a carbohydrate-based composition, and a combination thereof. Alternatively, the coating layer is a monosaccharide, a disaccharide, an oligosaccharide, a polysaccharide and combinations thereof. Specific carbohydrate binders illustratively include glucose, mannose, fructose, galactose, sucrose, lactose, maltose, xylose, arabinose, trehalose and mixtures thereof such as corn syrup; celluloses such as carboxymethylcellulose, ethylcellulose, hydroxyethylcellulose, hydroxy-methylethylcellulose, hydroxyethylpropylcellulose, methylhydroxyethyl-cellulose, methylcellulose; starches such as amylose, seagel, starch acetates, starch hydroxyethyl ethers, ionic starches, long-chain alkyl starches, dextrins, amine starches, phosphates starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth and locust bean gum; vegetable oils such as corn, soybean, peanut, canola, olive and cotton seed; complex organic substances such as lignin and nitrolignin; derivatives of lignin such as lignosulfonate salts illustratively including calcium lignosulfonate and sodium lignosulfonate and complex carbohydrate-based compositions containing organic and inorganic ingredients such as molasses. Suitable protein binders illustratively include soy extract, zein, protamine, collagen, and casein. Coating layers operative herein also include synthetic organic polymers capable of promoting or producing a tackified, adhesive coating. Such coating layers illustratively include ethylene oxide polymers, polyacrylamides, polyacrylates, polyvinyl pyrrolidone, polyethylene glycol, polyvinyl alcohol, polyvinylmethyl ether, polyvinyl acrylates, polylactic acid, and latex. In a preferred embodiment, the coating layer is calcium lignosulfonate, molasses, a liquid corn starch, a liquid corn syrup or a combination thereof. Often a coating layer is desired that has an adhesive tack for the subsequent adherence of additional materials such as a second active agent. Carbohydrates and synthetic organic polymers are representative of such tackifying coating layer materials.

Depending on the nature of the coating layer, inventive loaded grain particulate is rendered as a delayed release carrier based upon the thickness in composition of the coating layer. For such a coating layer, active agent release from a loaded grain particulate is optionally triggered by exposure to moisture, soil microbe digestion, osmosis, or diffusion.

Alternatively, a second active agent that is solid at 20° Celsius is formed as a melt that overlays the grain particulate loaded with the internalized active agent. It is appreciated that application of a melt coating over an active agent loaded grain particulate requires thermal management to limit volatilization of the active agent during melt application with the second active agent as a coating.

Pesticides suitable to permeate a free flowing grain particle include pyrethroids such as bifenthrin, permethrin, deltamethrin, lambda cyhalothrin, cyfluthrin, or betacyfluthrin; organophosphates such as chlorpyrifos; limonoids such as azadirachtin or meliartenin; phenyl pyrazoles or oxadiazines such as indoxacarb; phthalic acid diamides such as flubendiamide and anthranilic diamides.

A pesticide powder is adhered to a spent fermented grain particle via an intermediate coating layer. Alternatively, an active agent is applied as a melt to form a solid, second active agent crystallized layer. Preferably, pesticide powder is sized such that the powder grain diameter has a mean particle diameter of less than 10% that of the spent fermented grain particle diameter. More preferably, the pesticide powder has a mean diameter of less than 2% that of the spent fermented grain particle diameter. Effectively, any conventional pesticide powder is operative within the present invention. Operative pesticide powders within the present invention illustratively include carbamates such as carbaryl (1-naphthyl N-methylcarbamate), neonicotinoids or nitroguanidines such imidacloprid, thiomethoxam, clothianidin or dinotefuran; diacylhydrazines such as halofenozide; neonicotines such as floconamid; organophosphates such as trichlorfon and pyrazoles such as fipronil. It is appreciated that multiple active pesticide agents are readily formulated within a pesticide powder operative herein, with an herbicide active agent or other types of active agents.

Preferably, the permeated pesticide active agent and surface coated second active agent pesticide are chosen to afford a measure of synergy in effect therebetween. Synergistic effect is noted where less of an active agent is necessary to achieve a given effect when that agent is delivered in concert with a second agent. Biological synergy is obtained when two or more pesticides are present within an inventive granule and operate on different pest species, different life stages of a pest, or act simultaneously on a single pest target.

The selection of the inventive components can also be made to afford a chemical synergism. For example, it is well known that carbaryl, while it is fairly efficacious and broad spectrum in its insecticidal functioning under optimal conditions, sometimes does not function well, especially if the environment has a high pH. Within the range of pH normally encountered in nature, the half-life of a carbamate pesticide varies from several hours to several days duration; therefore it may be inconsistent in pest control. The choice of a liquid pesticide or adjuvant therefor that produces acidic degradation products in proximity to carbaryl serves to extend the carbaryl persistence half-life. The sustained release of a permeated active agent from within a grain particulate coupled with a triggered release through the compromise of a coating layer facilitates usage of short active life active agents.

One specific example of an inventive particle having synergistic pesticide interactions includes a particle permeated with bifenthrin solution that in turn has a carbamate overlayer either through melt coating or an intermediate coating layer. Other active agent combinations in an inventive granule include combinations of: bifenthrin and imidacloprid; bifenthrin and halofenozide; and lambda cyhalothrin and thiamethoxam.

Herbicides suitable to permeate a free flowing grain particulate are limited only by compatibility with the other inventive granule particulate components. Owing to the sustained release of an herbicide impregnated within free flowing spent fermented grain particulate, release of herbicides is particularly advantageous and with inclusion of a coating layer that indicates release upon a predetermined amount of rain coincides with certain weed outbreaks. Representative active agent lipophilic herbicides illustratively include acetochlor, alachlor, ametryn, amidosulfuron, anilofos, atrazine, azafenidin, azimsulfuron, benfluralin, benfuresate, bensulfuron-methyl, bensulide, benzfendizone, benzofenap, bromobutide, bromofenoxim, butachlor, butafenacil, butamifos, butralin, butylate, cafenstrole, carbetamide, chlorbromuron, chloridazon, chlorimuron-ethyl, chlorotoluron, chlorpropham, chlorsulfuron, chlorthal-dimethyl, chlorthiamid, cinidon-ethyl, cinmethylin, cinosulfuron, clomazone, clomeprop, cloransulam-methyl, cyanazine, cycloate, cyclosulfamuron, daimuron, desmedipham, desmetryn, dichlobenil, diflufenican, dimefuron, dimepiperate, dimethachlor, dimethametryn, dimethenamid, dinitramine, dinoterb, diphenamid, dithiopyr, diuron, EPTC, esprocarb, ethalfiuralin, ethametsulifuron-methyl, ethofumesate, ethoxysulfuron, etobenzanid, ferioxaprop-ethyl, fenuron, flamprop-methyl, flazasulfuron, fluazolate, fluchloralin, flumetsulam, flumiclorac-pentyl, flumioxazin, fluometuron, fluorochloridone, flupoxam, flurenol, fluridone, fluroxypyr-1-methylheptyl, flurtamone, fluthiacet-methyl, halosulfuron, hexazinone, imazosulfuron, indanof an, isoproturon, isouron, isoxaben, isoxaiflutole, lenacil, linuron, mefenacet, metamitron, metazachlor, methabenzthiazuron, methyldymron, metobenzuron, metobromuron, metolachlor, metosulam, metoxuron, metribuzin, metsulifuron, molinate, monolinuron, naproanilide, napropamide, neburon, nicosulfuron, norfiurazon, orbencarb, oryzalin, oxadiargyl, oxadiazon, oxasulfuron, pebulate, pendimethalin, pentanochlor, pentoxazone, phenmedipham, piperophos, pretilachlor, primisulfuron, prodiamine, profluazol, prometon, prometryn, propachlor, propanhl, propazine, propham, propisochlor, propyzamide, prosulfocarb, prosulfuron, pyraflufen-ethyl, pyrazogyl, pyrazolynate, pyrazosulfuron-ethyl, pyrazoxyfen, pyributicarb, pyridate, pyriminobac-methyl, quinclorac, quinmerac, rimsulfuron, siduron, simazine, simetryn, sulcotrione, sulfentrazone, sulfometuron, sulfosulfuron, tebutam, tebuthiuron, terbacil, terbumeton, terbuthylazine, terbutryn, thenyichlor, thiazopyr, thidiazimin, thifensulfuron, thiobencarb, tiocarbazil, triallate, triasulfuron, tribenuron, trietazine, trifluralin, triflusulfuron and vernolate. Representative active agent hydrophilic herbicides illustratively include acifluorfen, acrolein, amitrole, asulam, benazolin, bialaphos, bromacil, bromoxynil, chloramben, chloroacetic acid, clopyralid, dalapon, dicamba, dichlorprop difenzoquat, diquat, endothall, fenac, fenoxaprop, flamprop, flumiclorac, fluoroglycofen, flupropanate, fomesafen, fosamine, glufosinate, glyphosate, imazameth, imazamethabenz, imazamox, imazapic, imazapyr, imazaquin, imazethapyr, ioxynil, mecoprop, methylarsonic acid, naptalam, nonanoic acid, paraquat, picloram, quinclorac, sulfamic acid, triclopyr and water-soluble salts thereof.

By way of example, glyphosate permeated into spent grain particulate is particularly well suited for application to genetically modified corn fields to treat broad leaf C3 plant weed infestations. Preferably, corn based grain is used to form particulate for broadcast spreading onto corn crops. Soil supporting other grain crops are similarly preferred to be exposed to inventive particulate or agglomerated carriers formed spent ferment grain from the same type of grain as the crop.

An herbicide powder is adhered to a spent fermented grain particle through an intermediate coating layer or applied as a melt to form a solid, second active agent crystallized layer. Preferably, herbicide powder is sized as detailed above with respect to pesticide powder. Effectively, any conventional herbicide powder is operative within the present invention. Operative herbicide powders within the present invention are limited only by compatibility with the other inventive granule particulate components. It is appreciated that multiple active herbicide agents are readily formulated within an herbicide powder operative herein or in combination with a pesticide powder or other active agent.

Alternatively, spent fermented grain is also ground into fine particles that are in turn agglomerated with resort to a binder to form a carrier granule for the delivery of an active agent. As such, spent fermented grain particles represent a substitute for all or some of the carrier granule particles detailed in co-pending application Ser. Nos. 12/234,898; 10/372,579; 11/301,171; 11/327,098; 11/327,099; 11/556,290; 11/757,646; 11/843,409; 12/108,307; 12/106,600 and 12/106,600. Suitable binders for agglomerating spent fermented grain particles together and to disparate substances as detailed in these co-pending application are those materials detailed above as coating layers. While the cost of spent fermented grain tends to be greater than many agricultural stalk and husk materials, the comparatively high fertilizer nutrient value of spent fermented grain offsets this difference and provides further advantage in reducing processing associated with blending synthetic fertilizer material therewith.

Those patent applications mentioned herein are intended to be incorporated by reference to the same extent as if each individual patent was explicitly and individually incorporated by reference.

The foregoing description is illustrative of particular embodiments of the invention, but is not meant to be a limitation upon the practice thereof. The following claims, including all equivalents thereof, are intended to define the scope of the invention.

1. A process for enhancing a soil comprising:
applying a quantity of a free flowing spent fermented grain particulate to the soil by broadcast spreading, said free flowing spent fermented grain particulate providing a sustained release of nutrients to the soil.

2. The process of claim 1 further comprising drying spent fermented grain at a temperature of less than 100° Celsius to form said free flowing spent fermented grain particulate prior to the applying step.

3. The process of claim 1 further comprising impregnating said free flowing spent fermented grain particulate with an active agent of a form of: a liquid at 20° Celsius, a solution of said active agent, a melt of said active agent, or a suspension of said active agent, said active agent being a fertilizer, insecticide, larvicide, plant growth regulator, fungicide, herbicide, insect growth regulator, bait attractant or combination thereof to form a sustained release active agent loaded spent fermented grain particulate.

4. The process of claim 3 wherein the impregnating is by capillary action permeation.

5. The process of claim 3 further comprising coating said sustained release active agent loaded spent fermented grain particulate to form a coating layer that retains said active agent.

6. The process of claim 3 further comprising deoiling said free flowing spent fermented grain particulate prior to the impregnating.

7. The process of claim 6 wherein said active agent is hydrophilic.

8. The process of claim 1 wherein said quantity of said free flowing spent fermented grain particulate is applied to the soil in an amount of between 10 and 10,000 kilograms per hectare.

9. A composition comprising: a free flowing spent fermented grain particulate having a mean particle size between 5 microns and 6 millimeters and a moisture content of less than 12 total weight percent.

10. The composition of claim 9 wherein the mean particle size is between 0.1 and 0.9 millimeter.

11. The composition of claim 9 further comprising an active agent within said particulate present from 0.01 to 5 total weight percent, said active agent being a fertilizer, insecticide, larvicide, plant growth regulator, fungicide, herbicide, insect growth regulator, bait attractant, or combination thereof.

12. The composition of claim 11 wherein said active agent is impregnated in said free flowing spent fermented grain particulate.

13. The composition of claim 12 further comprising a coating layer encompassing said free flowing spent fermented grain particulate and said active agent.

14. The composition of claim 13 wherein said layer is a carbohydrate or a synthetic chemical that interacts with water to form an adhesive.

15. The composition of claim 13 further comprising a solid second active agent adhered to said coating layer.

16. The composition of claim 12 herein said active agent is present at a concentration gradient between a surface and a core of a particle of said free flowing spent fermented grain particulate.

17. The composition of claim 9 wherein said free flowing spent fermented grain particulate is deoiled.

18. The composition of claim 9 wherein said active agent is an insecticide or an herbicide.

19. The composition of claim 9 wherein said active agent is a glyphosphate.

20. A composition comprising:
a ground spent fermented grain fragments bound together with a binder to form a carrier granule;
an active agent applied to said carrier, said active agent being a fertilizer, insecticide, larvicide, plant growth regulator, fungicide, herbicide, insect growth regulator, bait attractant, or combination thereof.
